(19) United States
(12) Patent Application Publication
(10) Pub. No.: US 2008/0232124 A1
(43) Pub. Date: Sep. 25, 2008

(54) Vehicular lamp

(75) Inventors: Hironori Tsukamoto, Shizuoka-shi (JP); Kazutami Oishi, Shizuoka-shi (JP)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: Koito Manufacturing Co., Ltd.

(21) Appl. No.: 12/070,993

(22) Filed: Feb. 22, 2008

(30) Foreign Application Priority Data
Mar. 23, 2007 (JP) 2007-076433

(51) Int. Cl. B60Q 1/00; H01J 9/02

(52) U.S. Cl. 362/487; 445/46

(57) ABSTRACT

A vehicular lamp 100 including a reflector 19 that reflects light from a light source 13 forward and is provided in a lamp chamber 15 formed by a lamp body 17 that opens forward and a transparent front cover 11 that is attached to the front opening portion of the lamp body 17. The lamp body 17 is formed using a first material to have a skeletal configuration in which a plurality of through holes h1 to h4 are provided. The through holes h1 to h4 are closed by sealants s1 to s2, which are formed from a second material that is integrally formed with the first material.

### BACKGROUND OF THE INVENTION

1. Field of the Invention

The present invention relates to a vehicular lamp. More specifically, the present invention relates to a vehicular lamp having a reflector that reflects light from a light source forward, with the reflector provided in a lamp chamber formed by a lamp body that opens forward and a transparent front cover that is attached to a front opening portion of the lamp body.

2. Description of the Related Art

A vehicular lamp mounted in a vehicle is preferably lightweight in order to decrease the vehicle driving load and should also be highly waterproof. In addition, a large opening for good light radiation is preferably secured while supporting a light source unit, a lens, a reflector, and the like therein, and a predetermined strength must be ensured with respect to the vibrations and impacts as well.

So as to meet such demands, in a vehicular lamp disclosed in Japanese Utility Model Application Publication (Kokoku) No. S55-17366, for example, the housing is made of synthetic resin, and a lamp body is attached to this resin-made housing, and a reflector is attached to the housing so as to extend along a portion of the inner surface of the housing. A portion of the housing that faces the back surface of the reflector is formed as a grid.

Generally, the housing of a vehicular lamp is formed with a thickness of approximately 2 mm, for example, to secure the strength. The reflector is press formed using a metal plate to attain a shape capable of covering substantially the entire area of the inner surface of the housing. At a center portion of the reflector, an attachment hole through which a lamp body is inserted is opened at a position corresponding to a through hole of the housing. A small latch hole is, further, provided in the vicinity of an edge portion of the reflector. By inserting a pin that projects from the inner surface of the housing through such a latch hole and caulking the pin, the reflector is attached to the housing so as to cover the inner surface of the housing that has the through hole.

The vehicular lamp disclosed in Japanese Utility Model Application Publication (Kokoku) No. S55-17365 is provided with a housing made of synthetic resin, and a reflector is attached to this housing so that it extends along the inner surface of the housing. A socket that grips a lamp body is held by a holder that is attached to the housing.

In this vehicular lamp, the housing is structured from a bowl-shaped portion and a flange portion that extends outward from the edge of an opening formed in the bowl-shaped portion. A through hole is opened over practically the entire back surface of the bowl-shaped portion. The reflector is press formed using a metal plate so as to have the same curvature as the bowl-shaped portion of the housing. The reflector is attached to the housing so as to cover substantially the entire inner surface of the housing.

The back surface of the reflector is pre-laminated with a polypropylene film. The reflector is mounted and welded to the peripheral edge of the through hole of the housing, so that the reflector seals the through hole and is attached to the inner surface of the housing.

However, in the vehicular lamp disclosed in Japanese Utility Model Application Publication (Kokoku) No. S55-17366, through holes formed in the housing in a grid-shape are covered by a reflector that is press formed as a separate body using a metal plate, and the reflector is attached to the housing inner surface by inserting and caulking the pin projecting from the housing inner surface through the latch hole. Therefore, it is difficult to ensure that the reflector closely adheres to the entire periphery of the through holes to keep the waterproofing characteristic.

In the vehicular lamp disclosed in Japanese Utility Model Application Publication (Kokoku) No. 55-17365, the back surface of the reflector is pre-laminated with a polypropylene film. In addition, the reflector is mounted and welded to the peripheral edge of the through hole of the bowl-shaped portion of the housing. The through hole is sealed by attaching the reflector to the inner surface of the housing. Therefore, it is difficult to form the reflector made from a metal plate so as to have the same curvature as the bowl-shaped portion of the housing. In addition, since the materials with different thermal expansion coefficients are adhered to each other, gaps are prone to occur on the adhesion surfaces over time. This also adversely affects the waterproofing characteristic.

### BRIEF SUMMARY OF THE INVENTION

The present invention was devised to resolve the above problems, and it is an object of the present invention to provide a vehicular lamp that has a predetermined strength and is capable of achieving a weight reduction, in addition to being highly waterproof.

In order to achieve the above object, the present invention provides a vehicular lamp that has a reflector that reflects light from the light source forward and is provided in a lamp chamber formed by a lamp body that opens forward and a transparent front cover that is attached to the front opening portion of the lamp body, and this vehicular lamp of the present invention is characterized in that the lamp body is formed using a first material to have a skeletal configuration in which a plurality of through holes are provided, and the through holes are closed by sealants that are formed from a second material integrally formed with the first material.

According to the vehicular lamp of the present invention having the above structure, a predetermined strength is secured for the lamp body even with a skeletal configuration, and the through holes eliminate the use of any excess material so as to make weight reduction of the lamp body possible. In addition, since the second material closing the through holes is integrally formed with the first material, the sealants are adhered to the through holes providing a highly watertight sealing characteristic.

In the vehicular lamp with the above structure, it is preferable that the second material formed into a sheet shape be placed in a forming die, after which the first material formed from a synthetic resin material be poured into the forming die, so that the lamp body and the sealant are integrally formed.

In the vehicular lamp with such a structure as described above, a so-called insert molding is carried out in which the second material formed into a sheet shape is first placed into a forming die, and then a melted first material is poured into the forming die. As a result, the sheet-shaped second material thermally deforms so as to become a sealant in a predetermined shape that follows the die, and addition, the second material fuses and integrally joins with the first material, which, in its melted state, forms the lamp body that follows the shape of the forming die. Thus, a lamp body having the through holes and the sealant sealing the through holes are integrally formed.

In addition, in the above-described lamp body of the present invention, the sheet-shaped sealant is adhered to the surface of the lamp body that is formed in a skeletal configuration, i.e., the sheet-shaped sealant is adhered to a skeletal structure region (a rib) that forms the peripheral edge of the through holes, thereby sealing the through holes. Since the sealant is formed by the second material of a sheet shape, it is possible to seal the through holes, which occupy a large area of the lamp body, using the second material. In addition, since the sealant can be formed by the second material of a sheet shape, it is possible to use a thin silicon-based (e.g. elastomeric) sheet.

According to the present invention, furthermore, the vehicular lamp may have such a structure that the first material formed from a synthetic resin material is poured into a forming die, after which the second material formed from a synthetic resin material is poured into the forming die, so that that the lamp body and the sealant are integrally formed.

In the vehicular lamp of this structure, by pouring the melted first material into the forming die, a lamp body that conforms to the forming die is obtained. In addition, since before cooling and hardening of the first material, a transfer is made to a forming die that corresponds to the formed portion of the sealant, and the second material is poured into the transferred forming die, the sealant formed from the second material fuses with and is formed on the lamp body, which is still hot and not yet hardened. As a consequence, a so-called co-injection molding is achieved and, a lamp body having through holes and a sealant that seals the through holes are integrally formed;

It is preferable in the present invention that the second material be formed from a material with a smaller specific gravity than that of the first material, and that the through holes provided in the lamp body be sealed or filled by the second material.

According to the vehicular lamp with the above structure, by the co-injection molding, for example, the second material formed from a material with a smaller specific gravity than that of the first material can be used as the sealant to seal or fill the through holes of the lamp body to achieve integral formation. Therefore, a joining region of the first and second materials can be obtained in the thickness (depth) direction of the through holes, and the through holes can be sealed while having the same thickness as the lamp body. In other words, even when the sealant formed in the through holes is made thin for the purpose of weight reduction, there is no risk of reducing the joining region with the lamp body and lowering the joining strength.

As seen from the above, according to the vehicular lamp with the structure described above, the lamp body is formed using a first material to have a skeletal configuration in which a plurality of through holes are provided, and the through holes are closed by sealants that are formed from a second material and integrally formed with the first material. Therefore, a predetermined strength is secured for the lamp body even with a skeletal configuration, and the through holes eliminate any excess material to make the weight reduction of the lamp body possible.

In addition, the second material that closes the through holes is integrally formed with the first material, and the sealants obtained by the second material are adhered to the through holes for a highly watertight sealing characteristic.

As seen from the above, according to the present invention, it is possible to provide a vehicular lamp that has a predetermined strength and is capable of achieving a weight reduction, in addition to being highly waterproof.

### BRIEF DESCRIPTION OF THE SEVERAL VIEWS OF THE DRAWINGS

FIG. 1 is a horizontal cross-sectional view of a vehicular lamp according to an embodiment of the present invention;

FIG. 2 is a side view of the vehicular lamp shown in FIG. 1 with a front cover and an inner lens removed;

FIG. 3 is a vertical cross-sectional view of the vehicular lamp shown in FIG. 1 wherein the lamp is cut in the vehicle front-back direction in the vicinity of the light source unit of the lamp;

FIG. 4 is a perspective view of the vehicular lamp shown in FIG. 2 viewed from the back;

FIG. 5A is a cross-sectional view of an essential portion of a work and a forming die for explaining a formation procedure of a lamp body according to one embodiment of the present invention, and FIG. 5B is a cross-sectional view of an essential portion of a work and a forming die for explaining another formation procedure of a lamp body according to another embodiment of the present invention;

FIG. 6A is a schematic diagram of the through hole portion in the lamp body according to one embodiment of the present invention, and FIG. 6B is a schematic diagram of the through hole portion in a lamp body according to another example embodiment of the present invention;

FIG. 7 is a schematic diagram of the through hole portion in a lamp body according to another embodiment of the present invention; and

FIG. 8 is a vertical cross-sectional view of a modification of the present invention in which a portion of a sealant is a gasket.

### DETAILED DESCRIPTION OF THE INVENTION

Hereinafter, the vehicular lamp according to an embodiment of the present invention will be described in detail with reference to the attached drawings.

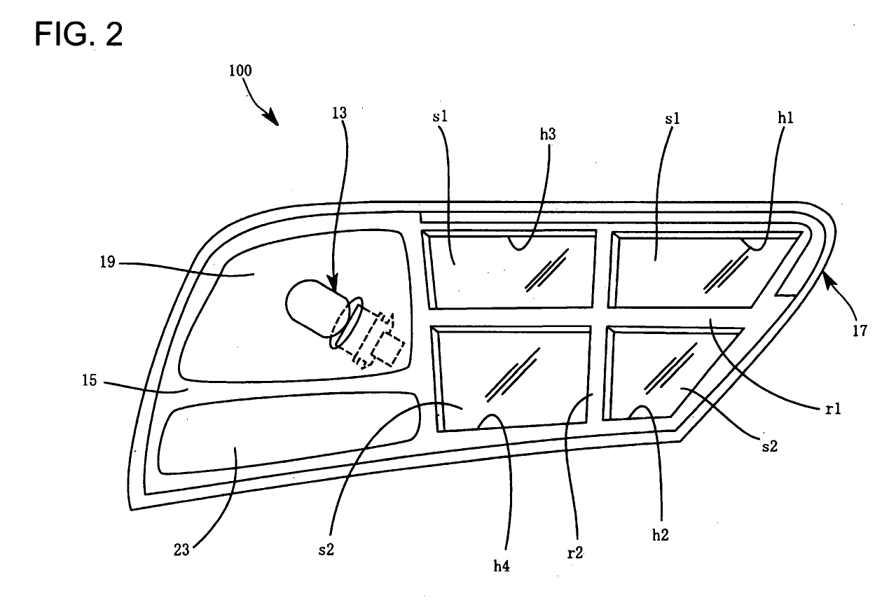

A vehicular lamp 100 of the shown embodiment includes a reflector 19 that reflects light from a light source 13 forward (leftward in FIG. 2). The reflector 19 is provided in a lamp chamber 15 formed by a lamp body 17 that opens forward and a transparent front cover 11 that is attached to the front opening portion of the lamp body 17.

The light source 13 in this embodiment is an incandescent bulb, and it can be a discharge lamp, or the like, and it also can be a semiconductor light-emitting element such as an LED. Furthermore, a so-called projector-type lamp unit in which a projection lens, a shade, or the like are disposed in front of the light source 13 may also be employed.

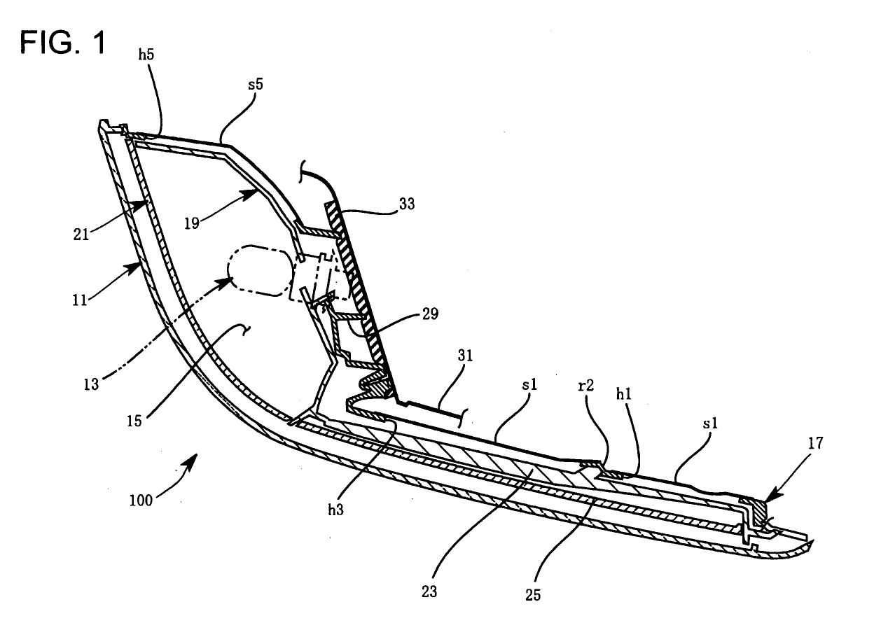

The front cover 11 is formed from a transparent synthetic resin material. As shown in FIG. 1, a peripheral edge portion thereof is welded to the lamp body 17, and the front cover 11 is provided so as to cover substantially the entirety of the forward opening portion of the lamp body 17. The front cover 11 is made from, for example, polycarbonate resin (PC resin), polycarbonate ABS resin (PC-ABS resin), acrylic resin (PMMA), or the like.

The lamp body 17 is integrally formed by a synthetic resin material, which is a first material. For example, polycarbonate resin, polycarbonate ABS resin, acrylic resin (PMMA), or the like are suitable for this synthetic resin material for the lamp body 17. The lamp body 17 may be formed in a concave shape at a portion that corresponds to the lamp chamber 15, and together with the front cover 11 the lamp body 17 forms a relatively large accommodation space therein.

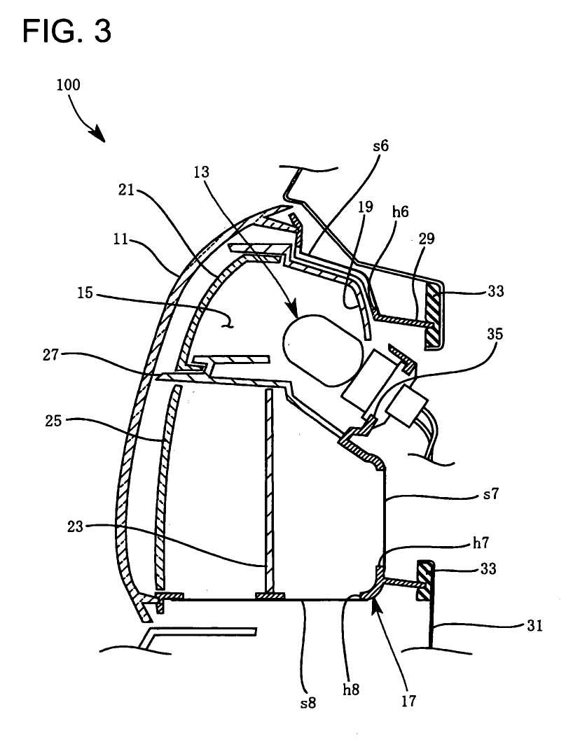

Accommodated within the accommodation space forming the lamp chamber 15 are the reflector 19 and an inner lens 21. The accommodation space that forms the lamp chamber 15 extends rearward along the vehicle side surface to form a flattened accommodation space. Accommodated within this flattened accommodation space is a reflector extension portion 23 and a lens extension portion 25 as seen from FIG. 1 that are held by a partition member 27 as shown in FIG. 3.

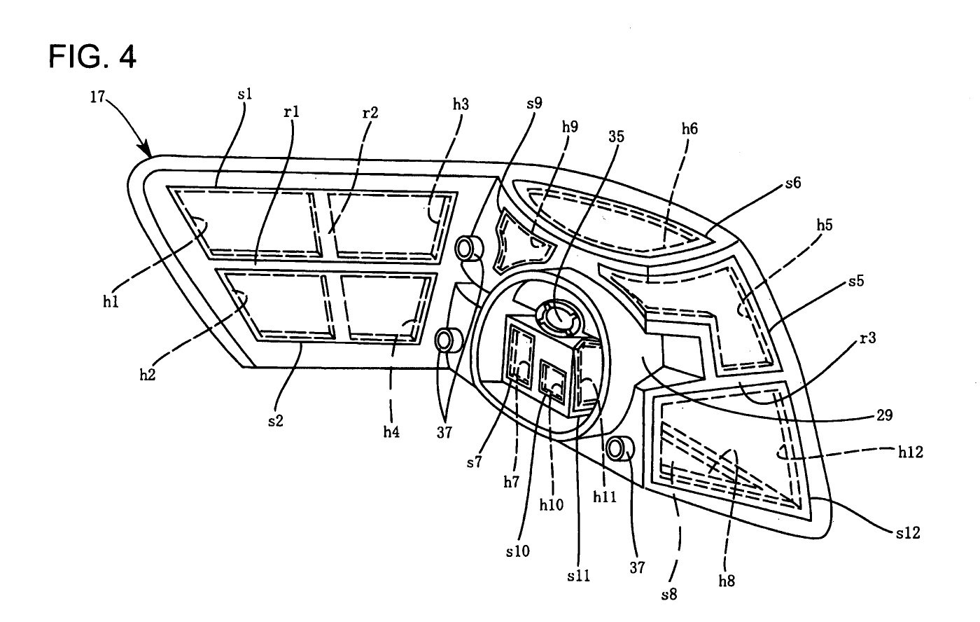

As seen from FIG. 4, a light source insertion portion 35 is provided so as to project from the back surface of the lamp body 17. The light source 13, as seen from FIG. 1, is attached by insertion to the light source insertion portion 35 from the back surface side of the lamp body 17. A light source attachment portion 29, which is a cylindrical rib, is provided to project around the light source insertion portion 35. The projecting end of the light source attachment portion 29 is, as seen from FIG. 1, in contact with a vehicle body panel 31 via a gasket 33.

In addition, as shown in FIG. 4, a plurality of cylindrical fixing portions 37 are provided so as to project from the back surface of the lamp body 17. The lamp body 17 is fixed to the vehicle body panel 31 by fixing screws (not shown) that are threadably mounted in the inner side of the cylindrical fixing portion 37. In this structure, the gasket 33 achieves a watertight seal between the light attachment portion 29 and the vehicle body panel 31, thus preventing water droplets, dust, and the like from penetrating into the lamp chamber 15.

The lamp body 17 of the shown embodiment, as seen from FIGS. 1 to 4, is formed using a first material so that it has a skeletal configuration in which a plurality of through holes h1 to h12 are provided. In other words, the lamp body 17 includes a plurality of ribs r1, r2, r3, . . . that are formed so as to surround the through holes h1 to h12 so that the lamp body 17 has a grid-like configuration.

Accordingly, the lamp body 17 has a considerable weight reduction characteristic compared to a conventional lamp body having no through holes. Such a weight reduction lessens the load on the vehicular lamp 100 attached to a vehicle body and also reduces the material costs, in addition realizing a decrease in the vehicle driving load (that leads to an increase in fuel efficiency).

These through holes h1 to h12 are closed by sheet-shaped sealants s1 to s12 which are formed from a second material that is formed together with the first material.

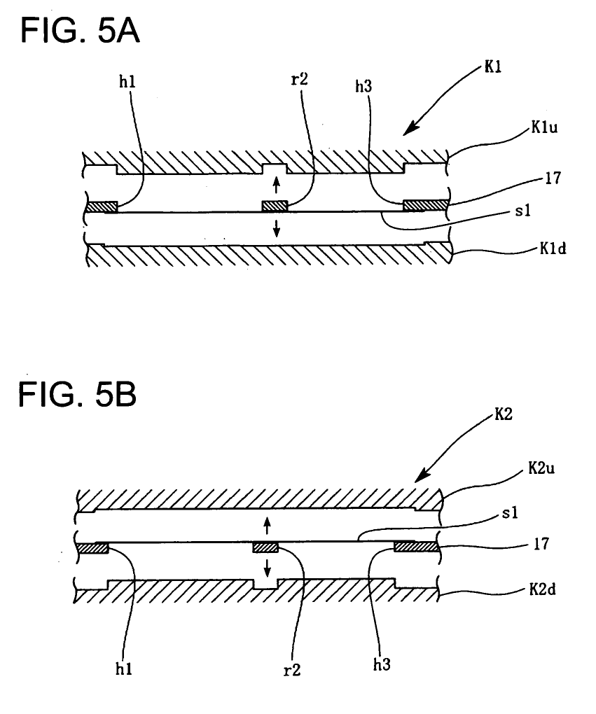

FIG. 5A is a cross-sectional view of the essential portion of a work and a forming die for explaining a formation procedure of a lamp body according to the shown embodiment, and FIG. 5B is a cross-sectional view of the essential portion of a work and a forming die for explaining another formation procedure of the lamp body.

In the lamp body 17 of the shown embodiment, as seen from FIG. 4, the sealants s1 to s12 are provided on the surface (mainly on the back surface) of the lamp body 17 so that they are on the outer side of the lamp chamber 15.

More specifically, a so-called insert molding is carried out, in which the sealants s1 to s12 formed from the second material and have been formed respectively in advance into a sheet shape by a thin silicon-based (e.g. elastomeric) sheet are first placed into a forming die K1 structured from an upper die K1u and a lower die K1d, and then the first material, which is a melted PC resin, ABS resin, or the like is poured into the forming die K1. Then, the sheet-shaped second material thermally deforms such that the sealants s1 to s12 are respectively formed into a predetermined shape that follows a cavity inner surface of the lower die K1d, and in addition, the second material fuses and integrally joins with the first material, which, in its melted state, forms the lamp body 17 so as to follow the cavity inner surface of the forming die K1. Thus, as shown in FIG. 5A, the lamp body 17 that includes the through holes h1 to h12 is laminated and integrally formed with the sealants s1 to s12 that respectively seal the through holes h1 to h12. In this structure, the sealants s1 to s12 are integrally formed on the outer surface side of the lamp chamber 15 of the lamp body 17.

In the lamp body 17 of the shown embodiment, the thickness of the ribs r1, r2, r3, . . . is varied at parts. In other words, a support portion around the light source attachment portion 29 of the light source 13 and the inner lens 21 where the rigidity is required may be formed with a thickness similar to that in the conventional art (approximately 2 mm), while a design portion where the rigidity is not required may be formed thinner.

In the present invention, the sealants s1 to s12, as shown in FIG. 5B, may be integrally formed on the inner surface side of the lamp chamber 15 of the lamp body 17. In addition, the sealants s1 to s12 can be formed on both inner and outer surfaces of the lamp chamber 15 of the lamp body 17. Whether to dispose the sealants s1 to s12 on either or both of the inner and outer surfaces of the lamp body 17 may be determined in consideration of the trimming eristic of forming dies K1 and K2 for the lamp body 17.

Furthermore, as shown in FIG. 4, each one of the through holes h1 to h12 may be sealed by a single sealant (see, e.g., the through hole h6 which is sealed by a single sealant 6), and further a plurality of through holes may be sealed by a single sealant (see, e.g., the through holes h1 and h3 which are sealed by a single sealant s1).

In the above description, the vehicular lamp is formed so that the second material which is in a sheet shape is placed in a forming die, and then the first material formed from a synthetic resin material is further poured into the forming die. However, in the present invention, it is also possible that the first material formed from a synthetic resin material is poured into a forming die, and then the second material formed from a synthetic resin material is further poured into the forming die 3, so that the lamp body and the sealant are integrally formed.

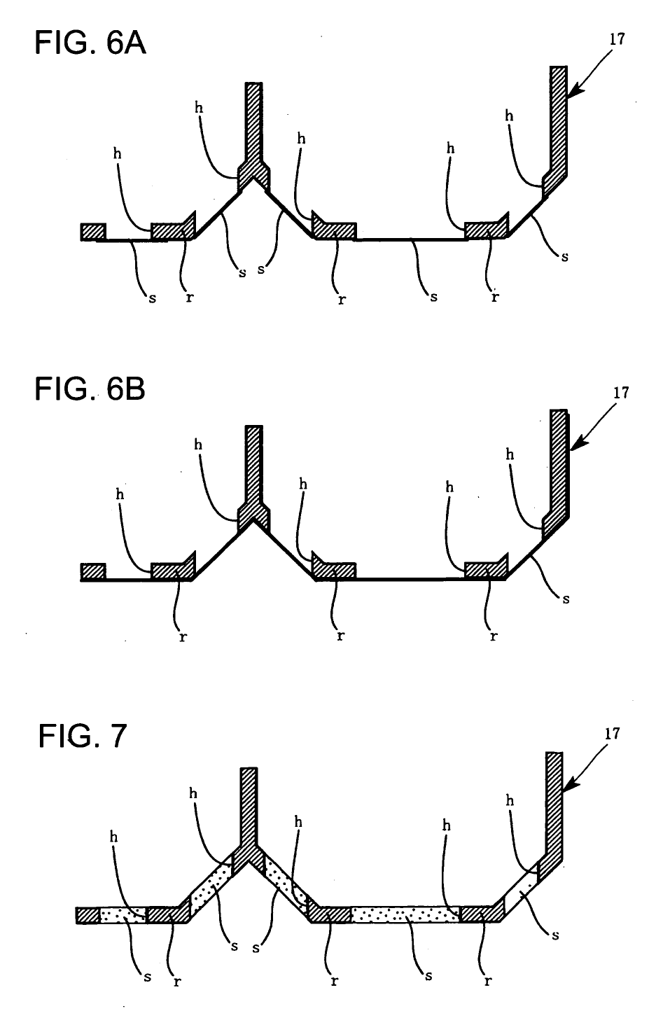

FIG. 6A is a schematic diagram of the through hole portions in the lamp body according to one embodiment of the present invention, and FIG. 6B is a schematic diagram of the through hole portions in a lamp body according to another embodiment.

In the structure shown in FIG. 6A, sealants s made from the second material and formed in a sheet shape with a thickness of approximately 0.1 to 1.0 mm are adhered to at least one surface of the lamp body 17. As the second material, any material (such as synthetic resin, rubber, silicon, or elastomer) that is ductile and has excellent joining compatibility with the first material is suitable for use. Namely, by using a thin sheet pre-formed into a sheet shape, it is possible to use a silicon-based material such as elastomer as the second material for the sealants s.

In this structure, the sheet-shaped sealants s are adhered to the surface of the lamp body 17 (the back surface of the lamp body 17) that is formed into a skeletal configuration. In other words, the sheet-shaped sealants s are adhered to the skeletal structure region (formed by, e.g. the ribs r) that forms the peripheral edge of the through holes h, so that sealants s seal the through holes h. By using the second material which is in a thin sheet shape in this manner, it is possible to seal the through holes h, which are large in size with respect to the entire size of the entire lamp body 17, using the second material.

In the present invention, the joining surfaces of the sealants s and the lamp body 17 (e.g. the joining surfaces of the ribs r, or the joining surfaces of the sealants s corresponding to the ribs r) may be subjected to a surface treatment such as embossing in order to improve the adhesion, and thus it is possible to provide an even better adhesion during the integral molding.

In addition, as shown in FIG. 6B, in the present invention, instead of using a plurality of sealants s as described above, a plurality of the through holes h can be all sealed at once by a single sheet-shaped sealant s.

Furthermore, the same type of material may be used for the first material forming the lamp body and for the second material forming the sealant. For example, polypropylene (referred to as PP below) may be used for the lamp body 17, and PP may also be used for the sealant(s) s so as to improve the adhesion of the lamp body 17 and the sealant(s).

FIG. 7 is a schematic diagram of the through hole portions in a lamp body according to another embodiment.

As shown in FIG. 7, according to the present invention, it is also possible to integrally form the lamp body 17 with sealants s by first pouring the first material made from melted PC resin, ABS resin, or the like into a forming die, and then pouring the second material made from synthetic resin having a smaller specific gravity than the first material into a forming die.

and then pouring the second material made from synthetic resin with a smaller specific gravity than the first material into the forming die.

In other words, by pouring a melted first material into the forming die (not shown), the lamp body 17 is formed following the shape of the forming die, then before cooling and hardening of the first material, a transfer is made to a forming die that has cavities corresponding to the intended locations of the sealants s, and then the second material is poured into the transferred forming die. Accordingly, the sealants s formed from the second material fuse with and are formed in the lamp body 17 (or, more specifically, in the through holes of the lamp body 17), which is still hot and not yet hardened. As a consequence, a so-called co-injection molding is achieved.

Thus, the second material, which is made from material with a smaller specific gravity than the first material, can be integrally formed as the sealant s inside the through holes h of the lamp body 17. Accordingly, in the structure of FIG. 7, a joining region between the lamp body 17 and the sealants s is obtained in the thickness (depth) direction of the through holes h, and the through holes h are sealed while having the same thickness as the lamp body 17, without the thickness of the sealant being added onto the thickness of the lamp body. In other words, since the sealants s formed in the through holes h are not made thinner than the lamp body 17 for the purpose of weight reduction, there is no risk of lowering the joining strength that would be caused by reduction of the joining region between the lamp body 17 and the sealants s.

However, it is possible in the present invention to use a second material that has a specific gravity which is heavier (greater) than that of the first material, for example, and in such a case, the thickness of the sealant(s) s is thinner than the thickness of the lamp body 17.

According to the vehicular lamp 100 of the present invention structured as described above, a predetermined strength is secured for the lamp body 17 even though it has a skeletal configuration, and the through holes h1 to h12 eliminate use of any excess material and make a weight reduction of the lamp body 17 possible. In addition, the second material that seals the through holes h1 to h12 is integrally formed with the first material and the sealants s1 to s12 are adhered to the through holes h1 to h12 for securing a highly watertight sealing characteristic. Thus, the vehicular lamp 100 has a predetermined strength and is still capable of achieving a weight reduction, in addition to being highly waterproof.

Also, in the present invention, the sheet-shaped sealants s1 to s12 may be provided on the inner side or the outer side of the lamp body 17, and the reflector 19 may be disposed at a predetermined position within the lamp chamber 15 as a separate body. Therefore, it is possible to easily adapt to various desired designs. Furthermore, since there is increased flexibility with respect to where the reflector 19 is disposed, the degree of freedom regarding the light distribution can also be increased.

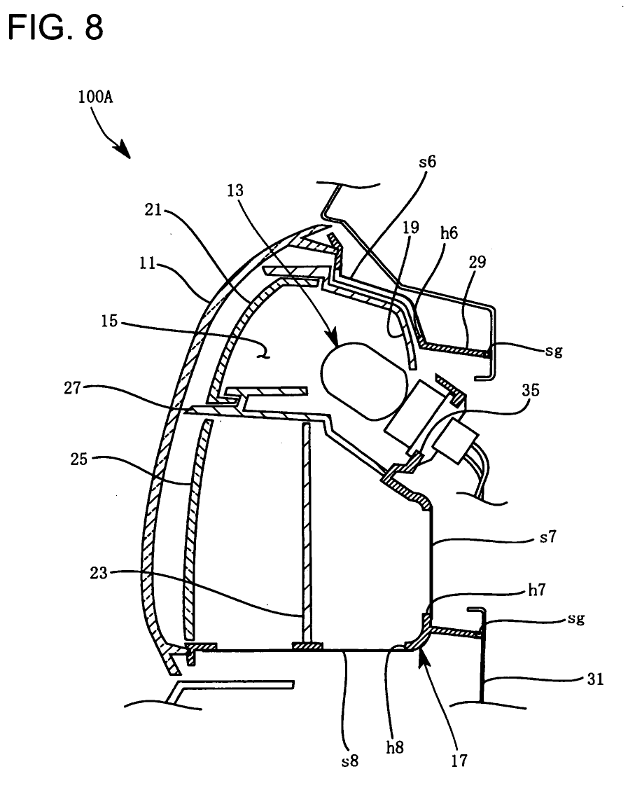

Next, a modification of the vehicular lamp 100 according to the above-described embodiment will be described with reference to FIG. 8.

FIG. 8 shows the modification in which a portion of the sealant is formed as a gasket.

In a vehicular lamp 100A according to the modification shown in FIG. 8, the cylindrical light source attachment portion 29 projects from the back surface of the lamp body 17, and the entire periphery of a projecting end thereof is integrally formed with a lip sg, which is a film-like gasket formed from the same material as the sealants s1 to s12, i.e., the second material. The lip sg is preferably formed using a silicon-based material having elasticity.

More specifically, by integrally forming the second material on the entire periphery of the projecting end of the light source attachment portion 29 at the same time the sealants s1 to s12 are integrally formed with the lamp body 17, the lip sg is integrally formed on the projecting end of the light source attachment portion 29. Hence, a watertight seal can be achieved between the light source attachment portion 29 and the vehicle body panel 31 by the lip sg, without providing the gasket 33 between the projecting end of the light source attachment portion 29 and the vehicle body panel 31. As a consequence, the number of parts is reduced since the gasket 33 is no longer necessary, and ease of assembly is improved when attaching the vehicular lamp 100A to the vehicle body panel 31.

It should be noted that the structures of the lamp body, the front cover, the reflector, the through hole, the sealant, and the like of the vehicular lamp of the present invention are not particularly limited to the structures described above; and various configurations are naturally conceivable in the present invention.

1. A vehicular lamp comprising a reflector that reflects light from a light source forward and is provided in a lamp chamber formed by a lamp body that opens forward and a transparent front cover that is attached to a front opening portion of the lamp body, wherein
the lamp body is formed using a first material to have a skeletal configuration in which a plurality of through holes are provided, and the through holes are closed by sealants that are formed from a second material integrally formed with the first material.

2. The vehicular lamp according to claim 1, wherein the lamp body and the sealant are integrally formed such that the second material which is in a sheet shape is placed in a forming die, and the first material formed from a synthetic resin material is further poured into the forming die.

3. The vehicular lamp according to claim 1, wherein the lamp body and the sealant are integrally formed such that the first material formed from a synthetic resin material is poured into a forming die, and the second material formed from a synthetic resin material is further poured into the forming die.

4. The vehicular lamp according to claim 1, wherein the second material has a smaller specific gravity than that of the first material, and the through holes provided in the lamp body are sealed by the second material.

5. The vehicular lamp according to claim 1 wherein the second material is formed from a material with a smaller specific gravity than that of the first material, and the through holes provided in the lamp body are filled by the second material.

6. A method for making a lamp body for a vehicular lamp comprising a reflector that reflects light from a light source forward and is provided in a lamp chamber formed by a lamp body that opens forward and a transparent front cover that is attached to a front opening portion of the lamp body, said method comprising the ordered steps of:
forming a skeletal configuration of a first material in which a plurality of through holes are provided, and
closing the through holes with a second material which is integrally formed with the first material.

7. A method for making a lamp body for a vehicular lamp comprising a reflector that reflects light from a light source forward and is provided in a lamp chamber formed by a lamp body that opens forward and a transparent front cover that is attached to a front opening portion of the lamp body, said method comprising the ordered steps of:
setting a second material of a sheet-shape into a die having a skeletal configuration; and
forming in said die, on said second material, a skeletal configuration of a first material in which a plurality of through holes are provided, so that said through holes are closed by said second material integrally with said second material.
